(19) United States
(12) Patent Application Publication
(10) Pub. No.: US 2021/0054762 A1
(43) Pub. Date: Feb. 25, 2021

(54) GAS TURBINE ENGINE FAN BUMPER

(71) Applicant: PRATT & WHITNEY CANADA CORP., Longueuil (CA)

(72) Inventors: Richard IVAKITCH, Scarborough (CA); Tibor URAC, Mississauga (CA)

(21) Appl. No.: 16/660,990

(22) Filed: Oct. 23, 2019

Related U.S. Application Data
(60) Provisional application No. 62/889,685, filed on Aug. 21, 2019.

(51) Int. Cl. F01D 21/04; F01D 25/24

(52) U.S. Cl. CPC F01D 21/045; F04D 29/526; F01D 25/246

(57) ABSTRACT

A fancase surrounds a set of fan blades mounted for rotation about a central axis of a turbine engine. The fancase has an annular casing structure having an inner wall defining an outer flow boundary surface of a gaspath. An annular recess is defined in the inner wall. A metallic bumper is disposed in the annular recess and bonded to the annular casing structure for limiting fan orbiting during fan unbalanced conditions.

### CROSS-REFERENCE TO RELATED APPLICATIONS

This application claims priority to U.S. provisional patent application No. 62/889,685 filed Aug. 21, 2019, the entire content of which is incorporated by reference herein.

### TECHNICAL FIELD

The application relates generally to turbofan gas turbine engines and, more particularly, to a fancase.

### BACKGROUND

Under certain conditions a gas turbine engine fan can become unbalanced. This can result from ice accumulation and partial release or other foreign object damage (FOD) events such as bird ingestion. During these events, the fan orbiting will increase and generate undesirable unbalance and vibration.

In such instances, limiting the fan orbiting motion is desirable.

### SUMMARY

In one aspect, there is provided a fancase for surrounding a set of fan blades mounted for rotation about a central axis of a turbine engine, the fancase comprising: an annular casing structure having an inner wall defining an outer flow boundary surface of a gaspath; an annular recess defined in the inner wall; and a metallic bumper disposed in the annular recess and bonded to the annular casing structure.

In another aspect, there is provided a turbofan engine comprising: a fan having a rotor carrying a set of fan blades mounted for rotation about a central axis; a fancase surrounding the set of fan blades, the fancase having: an annular casing structure having an inner wall defining an outer flow boundary surface of a gaspath; an annular recess defined in the inner wall; and a metallic bumper disposed in the annular recess and bonded to the annular casing structure, the metallic bumper axially overlapping the set of fan blades.

In a still further aspect, there is provided a method of limiting orbiting motion of a fan rotor during an unbalanced condition, the method comprising: bonding a circumferentially segmented metallic bumper in an annular recess defined in a radially inner surface of a softwall fancase.

### DESCRIPTION OF THE DRAWINGS

Reference is now made to the accompanying drawing in which:

FIG. 1 is a schematic side cross-section view of a gas turbine engine including a fancase;

FIGS. 2 to 6 are detailed schematic cross-section views illustrating the various steps for installing a metallic bumper to an existing softwall fancase such as the fancase shown in FIG. 1;

FIG. 7 is an enlarged schematic cross-section view illustrating the axial position of the bumper relative to the fan blades; and

FIG. 8 is a schematic isometric view illustrating a circumferentially segmented embodiment of the bumper.

It will be noted that throughout the appended drawings, like features are identified by like reference numerals.

### DETAILED DESCRIPTION

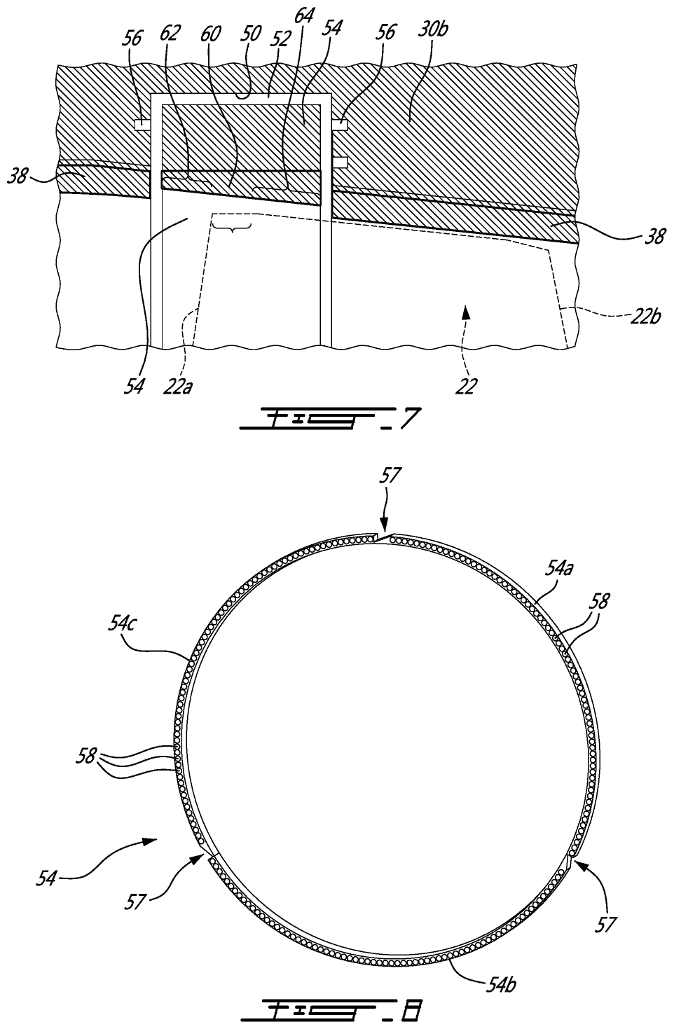

As will be seen hereinafter, a metallic bumper 54 (FIG. 8) may be integrated to a softwall or a hardwall fancase of a turbofan engine to limit fan orbiting and, thus, vibration. According to some embodiment, a metallic bumper is bonded into a softwall fancase to contact the fan if the same starts to orbit, thereby limiting its deflection.

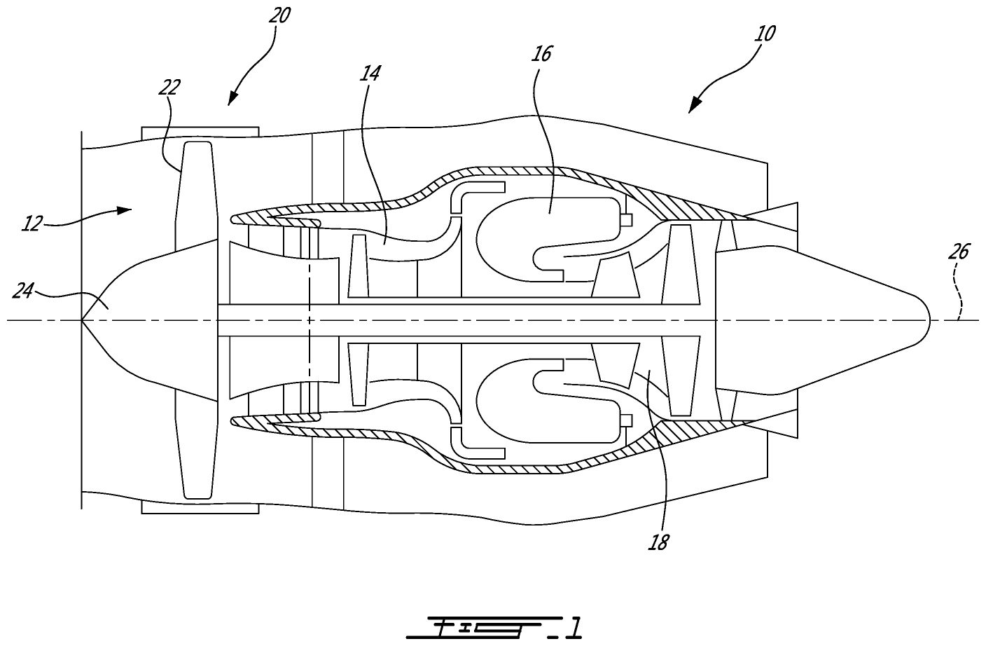

FIG. 1 illustrates an exemplary turbofan gas turbine engine 10 of a type provided for use in subsonic flight, generally comprising in serial flow communication a fan 12 through which ambient air is propelled, a multi-stage compressor 14 for pressurizing the air, a combustor 16 in which the compressed air is mixed with fuel and ignited for generating an annular stream of hot combustion gases, and a turbine section 18 for extracting energy from the combustion gases. The fan 12 includes a fancase 20 surrounding a circumferential array of fan blades 22 extending radially outwardly from a rotor 24 mounted for rotation about a central axis 26 of the engine 10. It should be noted that the terms “radial”, “axial” and “circumferential” used throughout the description and the appended claims, are defined with respect to the central axis 26 of the engine 10. The terms “upstream”, “downstream”, “front”, “forward”, “aft” and “rear” used throughout the description and the appended claims are defined with respect to the flow direction of air being propelled through the engine.

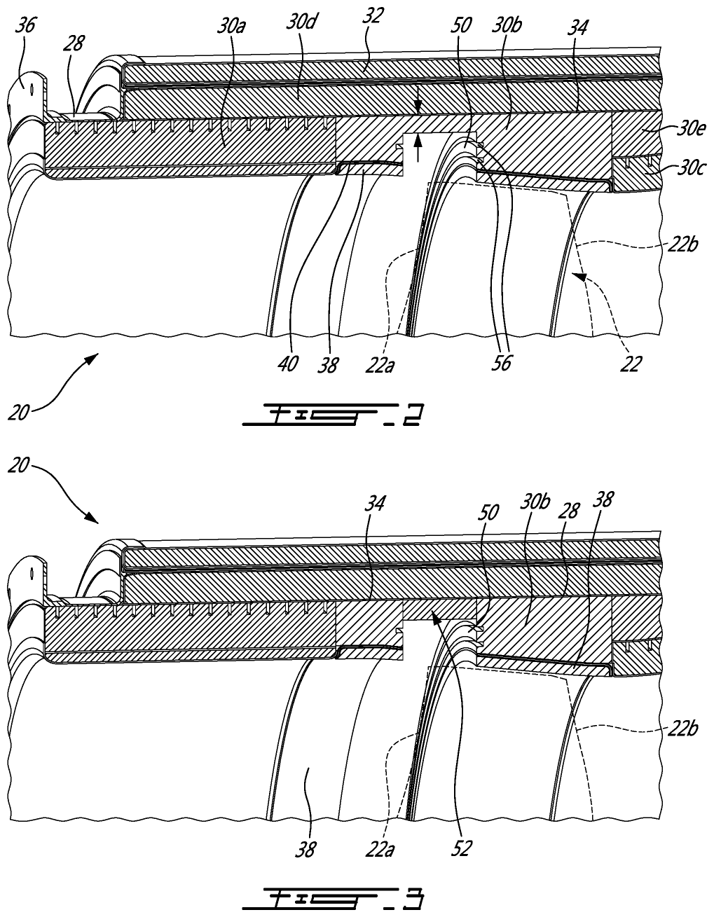

FIGS. 2 to 6 illustrate sequential steps for retrofitting the bumper 54 to an existing fancase, such as fancase 20 illustrated in FIG. 1. In the illustrated example, the fancase 20 has an annular softwall sandwich fancase structure designed for containing blade fragments or blades during a fan blade-off (FBO) event. Softwall fancase allows a fan blade to partially penetrate a thin-walled fan case during an FBO event with energy absorption due to the case penetration. In such softwall fan cases, energy is typically absorbed by a containment fabric layer, such as fabric containing para-aramid synthetic fiber known as Kevlar®, which has been wrapped around the outside shell structure of the fancase.

The exemplary fancase 20 generally comprises an annular case structure having a thin-walled steel support shell 28, honeycomb materials 30a, 30b, 30c, 30d and 30e forming a honeycomb material layer bonded or otherwise suitably secured to a radially inner side of the shell 28, a structural liner 34, such as a thin-walled annular aluminum inner wall, positioned within the support structure shell 28 and embedded in the honeycomb material layer and bonded or otherwise suitably secured to the support structure shell 28, and an outer containment fabric layer 32 (e.g. Kevlar®) wrapped around the shell 28.

In the illustrated embodiment, the shell 28 is provided in the form of a one-piece continuous annular steel component. As shown, the support structure shell 28 may be provided with a radially extending front forged steel ring 36 to provide a mounting device for connecting the fancase 20 to a nacelle casing of the engine 10.

An abradable tip clearance control layer 38 may be provided on the radially inner side of the honeycomb material 30b such that the abradable tip clearance control layer 38 axially spans the tips of the blades 22 in order to enable close clearances between the blade tips and the radially innermost surface of the fancase 20. As show in FIGS. 2, 3 and 7, the abradable layer 38 extends from a location axially upstream of the leading edge 22a of the fan blades 22 to a location axially downstream of the trailing edge 22b thereof. A layer of fiberglass or fiberglass tray 40 may be provided between the abradable layer 38 and the honeycomb material 30b.

As mentioned hereinbefore, a metallic bumper may be retrofitted to the fancase 20 to limit fan orbiting and thus vibration. As shown in FIG. 2, this may be accomplished by first machining a recess or pocket 50 through the abradable layer 38, the fiberglass tray 40 and the honeycomb material 30b to within a predetermined distance (T) from the structural liner 34. According to one embodiment, the distance (T) is comprised within 0.400 inches from the structural liner 34.

Then, as shown in FIG. 3, the bottom of the pocket 50 and the adjacent honeycomb cells are filled with a fiber-reinforced composite material 52, such as short fiber-reinforced epoxy, foaming adhesive or regular epoxy. The epoxy is allowed to cure and the inner diameter of the epoxy ring 52 is machined to provide a uniform surface for mounting the bumper 54, such as by bonding.

As shown in FIG. 4, the bumper 54 is then mounted into the pocket 50. A tape adhesive may be used on the outer diameter of the bumper 54 to bond the bumper 54 to the inner diameter of the epoxy ring 52. Foaming adhesive or the like may be used to bond the axially forward and the axially rearward face of the bumper 54 to the opposed axially facing sides of the honeycomb material 30b in the pocket 50. Grooves 56 in the opposed axially facing sides of the pocket 50 and lightening holes 58 in the adjacent axially facing sides of the annular bumper 54 should help adhesion.

As shown in FIG. 8, the bumper 54 is circumferentially segmented to permit installation in pocket 50. According to the illustrated embodiment, the bumper 54 includes 3 identical ring segments 54a, 54b and 54c. The ring segments 54a, 54b and 54c have opposed bevelled end portions 57 to facilitate ring assembly. The 3 ring segments 54a, 54b and 54c are individually mounted in the pocket 50 and bounded to the epoxy ring 52 and the honeycomb material 30b so as to form a circumferentially continuous bumper insert in the abradable layer 38 around the tip of the fan blades 22.

The ring segments 54a, 54b and 54c can be waterjet cut from metal plate. For instance, the ring segments 54a, 54b and 54c could be cut from a 1.5″ thick stainless steel plate. Steel was selected for durability. Aluminum would be too soft here. In some applications, fiberglass epoxy bumper rings could be a good option for short duration rubs like during a bird ingestion event. The outer diameter surface of the ring segments 54a, 54b and 54c can be milled for good contact with the fancase 20 (i.e. with the inner dimeter surface of the epoxy ring 52 in the pocket 50). All the other features of the ring segments 54a, 54b and 54c, including lightning holes 58 and the bevelled ends 57, can be water-cut. According to at least one embodiment, the ring segments 54a, 54b and 54c have an axial thickness of about 1.5 inches. Depending on the size of the fan, the axial thickness can vary from 0.5″ to 3″.

As shown in FIG. 5, once the ring segments have been installed in the pocket 50, the inner diameter surface of the ring segments 54a, 54b and 54c is machined to generally match the gaspath shape with an approximately 0.100″ offset from the nominal gaspath. The recess is dictated by normal fan deflections. So the offset I selected to prevent the blade fan tips from rubbing against the bumper during normal running or even during mild icing or bird ingestion events, since the rub will cause damage to the fan blades. On the other hand, the deepness of the he recess is limited by the max tip clearance the fan can tolerate without losing too much stall margin. For a particular application, the offset can range from 0.100″ to 0.160″. However, it is understood that the offset/recess will change for different size fans. According to one aspect, the offset can range from 0.050″ to 0.200″. That is the inner diameter surface of the ring segments 54a, 54b and 54c is machined so as to be recessed from the gaspath by a distance of 0.050″ to 0.200″.

Thereafter, as shown in FIG. 6, a suitable abradable coating 60 can be applied over the inner diameter surface of the ring segments 54a, 54b and 54c to fill the gap created by the pocket in in the abradable layer 38. The abradable compound 60 can be spray applied so as to be flush with the surface of the abradable layer 38 and, thus, match the nominal gaspath around the tip of the fan blades 22. The abradable compound is used to reduce rub loads at the blade tip and protect the blade tip from damage when rotor deflections occur and cause it to touch the case.

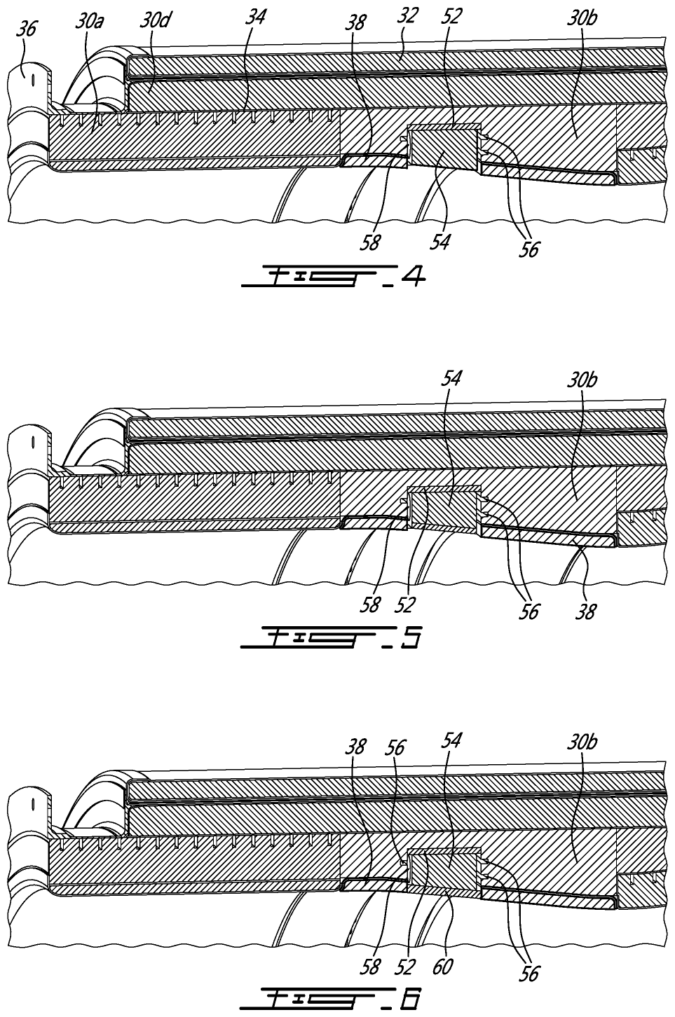

As shown in FIG. 7, the bumper 54 axially overlaps a front or upstream portion of the fan blades 22. According to some embodiments, the bumper 54 has a front portion 62, which extends axially forwardly up to 0.5 inches in front (i.e. upstream) of the leading edge 22a of the tip of the fan blades 22. According to some applications, the bumper can actually be positioned anywhere over top of the fan blade, and can extend slightly forward of the blade leading edge, but not necessarily required. Still according to some embodiments, the bumper 54 has a rear portion 64, which extends axially rearwardly up to 1.25 inches behind (i.e. downstream) a leading edge chamfer at the tip of the blades 22. According to some applications, the bumper can be anywhere over the blade, but typically above the forward half of the fan blade. Max aft location would be to center the bumper over mid-chord of the fan blade. This means half the bumper would be forward and half back of the mid-chord of the fan blade but fore of a mid-chord region of the blades.

A rub stacking angle is herein intended to refer to the top part of the blade angle to the fan case surface. In other words, a perfectly radial blade would have a 0 degree rub stack angle when it rubs the fan case abradable (or bumper). A negative rub stack angle for a blade would have the top of the blade shifted over slightly back from direction of rotation, so that as the blade rubs it bends away from the fan case rub surface. A positive rub stack angle would be the top of the blade shifted into the direction of rotation, which would result in the blade digging into the fan case as it rubs, and this is undesirable. Fan design, regardless of a metallic bumper, targets 0 or rearward rub stack angle.

According to one embodiment, the fan blade tip is all backswept and the rearward rub stack angle is 71 degrees at the leading edge, 78 degrees at mid-chord and 83 degrees at the trailing edge of the fan blades.

During normal engine operation, the bumper 54 is inactive. However, if the fan ever experience an unbalanced condition and starts orbiting around its axis, the fan blades will contact the metallic bumper 54. The metallic bumper 54 encircling the fan blades 22 will constrain the orbiting motion of the fan rotor, thereby limiting its radial deflection from its nominal position. The metallic bumper 54 is configured to resist rotor fan impacts resulting from fan unbalance conditions due to ice accumulation, partial blade release or other FOD events, such as bird ingestion. In that regard, metals, such as stainless steel, are chosen for their ability to withstand high impacts and assume high strength when impact occurs. A metallic bumper, such as a steel bumper, provides the required strength and rigidity to maintain its structural integrity when impacted by an orbiting fan rotor. Hi-strength materials, such as metals, transfer the load applied to one end to the other end. Accordingly, in the event of a contact between the fan rotor and the bumper 54, the load will be transferred from the metallic bumper 54 to the structural shell 28 of the fancase via the honeycomb material 30b, the epoxy material 52 and the structural liner 34 disposed between the metallic bumper 54 and the structural shell 28. A portion of the impact energy will be absorbed by the honeycomb material 30b, the epoxy ring 52 and the structural liner 34. It is understood that the characteristic of the bumper 54 may be adjusted for a particular application by selection of the size, shape and configuration of the metallic ring segments forming the bumper.

The above description is meant to be exemplary only, and one skilled in the art will recognize that changes may be made to the embodiments described without departing from the scope of the described subject matter. Modifications which fall within the scope of the described subject matter will be apparent to those skilled in the art, in light of a review of this disclosure, and such modifications are intended to fall within the appended claims.

1. A fancase for surrounding a set of fan blades mounted for rotation about a central axis of a turbine engine, the fancase comprising: an annular casing structure having an inner wall defining an outer flow boundary surface of a gaspath; an annular recess defined in the inner wall; and a metallic bumper disposed in the annular recess and bonded to the annular casing structure.

2. The fancase defined in claim 1, wherein the metallic bumper is circumferentially segmented into a plurality of ring segments.

3. The fancase defined in claim 2, wherein the ring segments are made out of steel.

4. The fancase defined in claim 2, wherein axially extending holes are defined in the plurality of ring segments.

5. The fancase defined in claim 1, wherein at least one of the ring segments is provided with opposed bevelled end portions.

6. The fancase defined in claim 1, wherein the metallic bumper is bounded to an inner diameter surface of a fiber-reinforced composite material provided in a bottom portion of the annular recess.

7. The fancase defined in claim 1, wherein the annular casing structure comprises a steel support shell and a layer of honeycomb material secured to a radially inner side of the steel support shell, the annular recess extending through the honeycomb material, and wherein the metallic bumper has opposed front and rear axially facing surfaces adhesively secured to honeycomb material.

8. The fancase defined in claim 1, wherein the metallic bumper has a metallic body having an inner diameter surface spaced radially outwardly from the outer flow boundary surface, and an abradable tip control layer on the inner diameter surface of the metallic body, the abradable tip control layer defining a portion of the flow boundary surface.

9. The fancase defined in claim 1, wherein the annular casing structure includes: a steel support shell, a layer of honeycomb material secured to a radially inner side of the steel support shell, and an abradable tip clearance control layer on a radially inner side of the honeycomb material, wherein the annular recess extends through the abradable tip clearance control layer and the honeycomb material.

10. The fancase defined in claim 9, wherein the annular casing structure further includes a structural liner radially between the layer of honeycomb material and the steel support shell, and wherein the annular recess has a bottom spaced radially inwardly from the structural liner.

11. A turbofan engine comprising:
a fan having a rotor carrying a set of fan blades mounted for rotation about a central axis;
a fancase surrounding the set of fan blades, the fancase having:
an annular casing structure having an inner wall defining an outer flow boundary surface of a gaspath;
an annular recess defined in the inner wall; and
a metallic bumper disposed in the annular recess and bonded to the annular casing structure, the metallic bumper axially overlapping the set of fan blades.

12. The turbofan engine defined in claim 11, wherein the metallic bumper extends axially fore of a tip of the set of fan blades.

13. The turbofan engine defined in claim 12, wherein each of the fan blades has a Leading edge chamfer at the tip thereof, and wherein the metallic bumper extends axially aft of the leading edge chamfer but fore of a mid-chord location of the fan blades.

14. The turbofan engine defined in claim 11, wherein the annular casing structure is a softwall fan case.

15. The turbofan engine defined in claim 14, wherein the softwall fan case includes a steel support structure shell, a honeycomb material disposed on a radially inner side of the steel support structure shell, and an abradable tip control layer disposed radially inwardly of the honeycomb material, and wherein the annular recess extends radially through the abradable tip control layer and the honeycomb material.

16. A method of limiting orbiting motion of a fan rotor during an unbalanced condition, the method comprising: bonding a circumferentially segmented metallic bumper in an annular recess defined in a radially inner surface of a softwall fancase.

17. The method defined in claim 16, wherein the softwall fancase includes a steel support structure shell, a honeycomb material disposed on a radially inner side of the steel support structure shell, and an abradable tip control layer disposed radially inwardly of the honeycomb material; the method comprising: machining the annular recess through the abradable tip control layer and the honeycomb layer.

18. The method defined in claim 17, further comprising filling a bottom end of the annular recess with a fiber-reinforced epoxy resin, waiting for the fiber-reinforced epoxy resin to cure into a solid ring, and then machining an inner diameter surface of the solid ring.

19. The method defined in claim 18, comprising bonding the circumferentially segmented metallic bumper to the inner diameter surface of the solid ring.

20. The method defined in claim 19, comprising machining an inner diameter surface of the circumferentially segmented metallic bumper so that the inner diameter surface of the metallic bumper be radially outwardly recessed relative to a nominal outer flow boundary surface of the softwall fancase.
